(19) United States
(12) Patent Application Publication
(10) Pub. No.: US 2002/0028854 A1
(43) Pub. Date: Mar. 7, 2002

(54) Photopolymerizable foam composition, procedure for obtaining three-dimensional parts by rapid prototyping, device for implementation, part obtained and use

(76) Inventors: Andre-Luc Allanic, Nancy (FR); Philippe Schaeffer, Atton (FR)

Correspondence Address: Ralph D'Alessandro, 3D Systems, Inc., 26081 Avenue Hall, Valencia, CA, 91355, US

(21) Appl. No.: 09/944,574

(22) Filed: Aug. 31, 2001

(30) Foreign Application Priority Data
Sep. 1, 2000 (FR) 00 11170

(51) Int. Cl. C08J 9/00

(52) U.S. Cl. 521/50.5

(57) ABSTRACT

The invention relates to a photopolymerizable foam composition to be used in a prototyping procedure, a procedure for obtaining three-dimensional parts through a rapid prototyping procedure from said composition, a device embodying said procedure, a part obtained from said procedure and a use of such a part. The foam composition is characterized by the fact that it includes:

a liquid or pasty part including at least 35% by volume of photopolymerizable material, including at least one photosensitive resin and at least one photoinitiator and between 0 and 65% by volume of pulverulent and/or additive load(s) and

a gaseous part in the form of a gas dispersion in said liquid or pasty part, with the gas taking the form of bubbles in a proportion from 10 to 95% by volume with respect to the volume of the composition.

### BACKGROUND OF THE INVENTION

1. Field of the Invention

The present invention relates to a photopolymerizable foam composition, a procedure to obtain three-dimensional parts using a rapid prototyping procedure employing said composition, an embodiment of said procedure, a part obtained from said procedure and a use of such a part.

2. Description of the Prior Art

The creation of three-dimensional parts with complex shapes in very competitive timeframes by rapid prototyping procedures consisting in transforming successive layers of a raw material into a second state, through the repetition of a cycle including a coating stage of the transformed parts by the raw material which has not yet been transformed with the aid of a device to perform the coating and a transformation stage of the raw material in at least one part of the working field by means of a device inducing the transformation is known in prior art.

In particular, rapid prototyping procedures implement stereolithography machines using a photosensitive liquid material which may be cross-linked or polymerized by illumination, by ultraviolet laser scanning for example, so-called powder sintering machines, employing a raw material in the form of a powder, whereby said powder may be locally bonded by a thermal effect, by infrared laser scanning for example, machines using heating filaments or cutting out sheets, or even using photosensitive pastes which are not distorted by the action of gravity, without necessarily being solids, which may be cross-linked or polymerized by illumination, by ultraviolet laser scanning for example.

The bubbles, which may be present in photosensitive liquids or pastes, are considered problems to be minimized. The presence of bubbles in stereolithography machines is detrimental since the bubbles may be trapped in the part during its manufacturing, leading to parts presenting surface holes (appearance defects) or internal holes (mechanical and optical property defects). In paste machines, the problem with the finished parts is the same, but the often very high viscosity of the pastes gives the bubbles no chance to disappear spontaneously over time. To remedy these problems, the manufacturers of liquids or pastes for rapid prototyping machines are led to modify their composition to minimize the appearance of bubbles. For example, the commercial resin SOMOS 6100, used in stereolithography machines, was replaced with the resin SOMOS 7100, which has similar properties, but is presented as having many fewer bubbles than the SOMOS 6100.

A growing need for rapid prototyping is to obtain low cost parts very quickly with machines, which are compatible with an office environment. The raw material, in particular the photosensitive resins, also called hereinafter photopolymerizable or light-cured resins, represent a significant cost in the process of creating parts by rapid prototyping. In addition, at the end of manufacturing, the finished parts are surrounded by the non-transformed raw material. In the case of liquids, the raw material is generally contained in a tank, and it is simple to extract the parts from the tank and allow them to drain. In the case of pastes, this prior operation of extracting the parts from their surrounding environment (non-transformed paste), generally requires a tedious manual process. A finishing and cleaning operation must then be undertaken, even in the case of liquid raw materials. This operation consists in a long and tedious manual cleaning of the parts performed by using hard or soft brushes, for example, and traditionally with the aid of alcohol or acetone type solvents, etc.

### BRIEF SUMMARY OF THE INVENTION

An initial object of this invention is to propose a new photopolymerizable composition to be used in a prototyping procedure, allowing for the rapid creation of finished parts at a low cost and/or to limit or even eliminate the manual cleaning phase.

This object is achieved by the fact that the composition according to the invention is in the form of a foam and is characterized by the fact that it includes the following:

a liquid or pasty part including at least 35% by volume of photopolymerizable material, including at least one photosensitive resin and at least one photoinitiator and from 0 to 65% by volume of pulverulent and/or additive load(s) and

a gaseous part in the form of a gas dispersion in said liquid or pasty part, with the gas taking the form of bubbles in a proportion of 10 to 95% by volume with respect to the volume of the composition.

As a special feature, the foam composition includes bubbles smaller than 0.3 millimeters in size in a proportion of at least 30% by volume with respect to the total volume of the bubbles.

Appropriately, the foam composition includes between 30 and 95% bubbles by volume.

As a special feature, the composition is a threshold material.

In one embodiment, the gas is air.

Appropriately, the foam composition includes a foaming agent type additive.

As a special feature, the foam composition includes a low pyrolysis residue pulverulent load such as a micronized wax.

The invention also related to a procedure for obtaining three-dimensional parts made of superimposed thin layers of raw material, obtained by means of the repetition of a cycle including a transformation stage of a layer which has just been placed by photopolymerization of the composition and a coating stage of the transformed layer by a new non-transformed layer, characterized by the fact that the layers are created using the composition as defined above.

As a special feature, the procedure includes, during at least one cycle, a creation stage of the foam composition by the dispersion of a gas which is partially a photopolymerizable liquid or paste or by expansion of a blend including a gas and a photopolymerizable liquid or paste component.

Appropriately, the procedure includes a final stage of automatic cleaning of the three-dimensional part by application of a solvent or by immersion in a solvent.

Another object of this invention is to propose a device for the embodiment of the aforementioned procedure.

This object is achieved by the fact that the procedure according to the invention, including:

means to induce the transformation of the raw material in a working field,

means of feeding the raw material,

means to perform at least one coating phase, said means including at least one recoater blade and a drive means for said recoater blade,

and means to move the volumes already transformed with respect to the working field, is characterized by the fact that the feed means include a pressurized container containing the liquid or pasty part of the foam composition and a means adapted to the vessel allowing for the expansion of the liquid or pasty part in order to form a determined quantity of foam composition for the creation of one or more layers.

As another special feature, the drive mechanism allowing for the movement of the volumes within a solvent bath and the device also includes means allowing for the extraction of the volumes transformed and cleaned from said bath.

The present invention is also related to the three-dimensional parts obtained by the aforementioned procedure. Appropriately, said parts are used as models in “lost wax” type casting procedures.

Thus, this invention takes the opposite position of prior methods aimed at limiting the presence of bubbles, on the contrary, to maximize the number of bubbles, until said bubbles form a significant part of the material. Since it is inevitable that bubbles will be present both on the surface and within the three-dimensional parts obtained from such a composition, hereinafter the finished parts, the bubbles must be small in size, so that the finished parts have a homogenous appearance to the eye.

The composition according to the invention includes 10 to 95%, preferably 30 to 95% by volume with respect to the apparent volume of bubbles in the composition, dispersed in a considerably homogenous fashion. It must be noted that in this invention, the various percentages by volume are determined at ambient air temperature and room atmospheric pressure. Preferably, the composition includes medium-sized bubbles smaller than 0.3 millimeter, preferably 0.1 mm in a proportion of at least 30%, for example 30 to 90%, preferably at least 90%, by volume with respect to the total volume of the bubbles. With bubbles smaller than 0.1 mm in diameter, we have a finished part whose surface quality is competitive with respect to that obtained by certain powder-sintering-based rapid prototyping procedures. Of course, the composition according to the invention may include undesired bubbles whose size and proportion correspond to those found in traditional photopolymerizable liquid or pasty compositions. These undesired bubbles may be the origin of surface defects on the finished parts, depending on the size of said bubbles found in the finished parts obtained from prior compositions.

The bubbles may be made of air or of any type of gas, such as a neutral gas.

The foam composition includes at least 35% by volume of the non-gaseous part of a photopolymerizable material and 0 to 65% by volume of the non-gaseous part of one or more pulverulent and/or one or more additive loads. The photopolymerizable material referenced above indicates a photopolymerizable resin or a blend of photopolymerizable resins of varying or similar fluidities, as well as a priming system. The resins used in this invention may be acrylic or epoxy type resins such as those used in traditional rapid prototyping using liquids or pastes. The priming system includes a photoinitiator adapted to the resin used and, potentially, an activating agent, which allows for the movement of the photoinitiator's activation wavelength, which, once activated, will react with the resin.

The composition may include any type of pulverulent load, whether mineral, organic or ceramic, traditionally used in stereolithography. Of course, in certain applications, such as the use of finished parts in “lost wax” type procedures described below, the load should present a slight residue after pyrolysis, and should consequently be organic in nature, such as a micronized wax.

The composition may also include additives such as a foaming agent to facilitate the dispersion of gas in the liquid or pasty part of the composition, and/or to stabilize it afterwards. This foaming agent is for example, a surface-active agent, such as the product marketed by the company Fisher Scientific under the trade name “Teepol,” or a traditional dishwashing liquid, in the presence of water.

The foam composition according to the invention may be obtained from a paste or a liquid including a photopolymerizable material as defined above, to which a specific quantity of bubbles of a specific size are added. The composition may thus include all types of additives used in traditional rapid prototyping procedures, such as thinners, which reduce the viscosity of the photopolymerizable material, a rheology control agent, an agent increasing the composition's reactivity to light. The term “paste” includes, in particular, materials with a high viscosity, greater than 10,000 mPa.s or the so-called “marked threshold” materials with a Bingham fluid type behavior. A “threshold” material does not flow (zero gradient) as long as the shear limitation applied to it does not exceed a minimum value. A “marked threshold” is considered to be reached when the value of this shear limitation is greater than 20 Newtons per square meter.

The foam composition is preferably comprised of a threshold or marked threshold material.

With respect to a similar composition, including a similar photopolymerizable material, but without bubbles, the foam composition according to the invention presents a lower apparent density, a higher opacity, and a completely different rheological behavior. Of course the mechanical properties of the three-dimensional parts obtained through rapid prototyping using the composition according to the invention are less ideal.

However, the foam compositions are lower in cost per unit of volume. The creation of a foam from traditionally used photosensitive liquids or pastes allows for the increase of material volume, virtually without cost increases, since the cost of inserting the gas is marginal. With an initial fixed volume of resin, it is possible to create a higher volume of parts, by a factor of 10 or higher.

In addition, the cleaning of the three-dimensional parts created from the foam composition is considerably facilitated by the enormous increase of the efficiency of traditional solvents. When a traditional solvent is used to clean a part surrounded by a foam according to the invention, specifically a foam including at least 30% gas by volume or more, the cleaning is clearly easier and requires practically no manual intervention. In fact, the solvent breaks up the bubbles forming the foam very easily, which allows not only for a rapid breaking up of large massive volumes of foam, but also a particularly clean finish on the surface of the parts, even in cavities which are difficult to access with brushes. In addition, for a given volume, the solvents are saturated less quickly than with resin in a liquid state. The choice of the solvent depends on the chemical composition of the photopolymer used in the composition, and may be, for example, isopropyl alcohol, acetone, or even water in certain cases.

Such ease of cleaning allows for the complete automation of the procedure. Thus, the finished parts may be cleaned automatically by simple application of a solvent or immersion in a solvent. The cleaning of the parts does not require any mechanical actions applied directly to the parts, by means of a brush, for example. Once solidified, the three-dimensional parts may be submerged in a solvent bath, potentially an ultrasound and/or agitated solvent bath.

In addition, unlike to prior photopolymerizable compositions, the composition according to the invention may be packaged in high-pressure containers, as described below.

The compositions according to the invention do not present any decantation problems, unlike what is currently observed in charged liquid resins currently commercially distributed for stereolithography, such as the resins known under the trade names SOMOS 4100 or JSR SCR-802. In fact, in these charged liquid resins composed of a resin and a high volumetric rate of pulverulent load, the resin and the load separate in two phases after several dozen minutes of relaxation, which poses problems for both storage and use in machines.

The finished parts may be appropriately used in lost wax casting procedures. “Lost wax” casting procedures consist in using a model, which is covered by successive baths of a ceramic shell. This ceramic shell is then dried, then the model+shell assembly is taken to a high temperature to provoke the evaporation or pyrolysis of the model part. The purpose of these operations is to create a ceramic mold whose internal form corresponds to that of the initial model, so as to be able to cast molten metal in this mold and create a copy of the initial model in metal. The ceramic shell is destroyed at the end of the operation to allow for the recovery of the metallic part. The models may be created by the traditional method using pearl board. When solid parts are made by rapid prototyping, with the photopolymerizable resins currently used in which the entire volume is solidified, they are not very reliable for use as models in lost wax casting. In fact, these resins have a high coefficient of thermal expansion and risk provoking cracks in the shells at high temperatures, thus rendering the resulting shells unusable. However, if hollow parts are made (the surface of the part is solidified, as is an internal structure forming cavities) by prototyping, good casting results may be obtained. In fact, the effects of thermal expansion are translated by forces, which tend to distort the part (inward) rather than exercising destructive actions on the ceramic mold. The procedures for creating hollow parts do however present some problems: complex computer pre-processing, internal cleaning difficulties of the parts after their creation, lack of local homogeneity, fragility of the parts created, etc.

The foam composition according to the invention allows for the creation of solid parts through a traditional rapid prototyping process which may be used as models in lost wax casting procedures, since said parts present a significant volumetric proportion of gas, which allows the shell cracking problems referenced above to be avoided. In fact, the foam solidified in successive layers which forms the parts possesses final thermo-mechanical properties similar to those of materials (pearl board, for example) whose compatibility with the lost wax casting procedures has been proven and which naturally behave like the hollow parts traditionally used in stereolithography for lost wax casting. Within the framework of this application, the parts do not actually need excellent mechanical properties. On the other hand, it is necessary that the cleaning of the part be as easy as possible, which is favored by the presence of numerous bubbles, thus significantly improving the efficacy of traditional cleaning solvents.

All of the above-referenced properties and advantages result in the foams according to the invention responding better than pastes or liquids to a growing need in rapid prototyping: obtaining low cost parts rapidly. In addition, the use of foams allows for the easy integration of the cleaning function in the production machines for said parts, thus making said machines compatible with an office environment.

As explained above, the foam composition according to the invention may be obtained from a photosensitive paste or liquid to which a determined quantity of bubbles is added. This gas bubble dispersion operation may be performed with a traditional mixer equipped with emulsifying disks, like those used in food processors, for example, to make mayonnaise or beat egg whites, or an air mixer or blender, or simply manually with a whisk. The presence of a foaming agent is beneficial to keep the mechanical mixing time reasonably low.

In another embodiment, the foam composition may be obtained by progressively incorporating a previously formed foam, composed of a dispersion of gas bubbles in a surfactant solution into a photosensitive paste or liquid.

This dispersion operation may also be performed by expansion of a pressurized container containing a photosensitive paste or liquid and a pressurized gas, in a manner similar to shaving cream type aerosols, rechargeable whipped cream dispensers or fire extinguishers.

Of course it is possible not to attempt to adapt a preexisting liquid or pasty resin, and directly to design a resin, which is easy to transform into a foam. In particular, in the event the formation and distribution of a foam in a pressurized container is desired, following the example of foams distributed on a large scale to the public (cosmetic foams), or industrially (injection foams, for example for car seats), it is beneficial to minimize the viscosity of the photosensitive resin.

According to the rheology of the foam composition, the prototyping will be done with liquid or paste stereolithography machines. The formation of a composite three-dimensional product from a paste type, marked threshold foam composition may be performed by a prototyping machine (“Optoform” type) with layers of a thickness equal to 100 μm such as that described in French patent application No. 99 02719 filed by the applicant. The formation of the three-dimensional product is obtained by the placement by means of at least one recoater blade and the polymerization by means of the illumination of thin superimposed layers of paste. To feed the machines with material, it is possible to fill the above-referenced machine's paste feed pistons with the previously mechanically prepared foam. Adaptations may be made to the recoater blade so as not to crack the emulsion, by reducing the shear limitations as much as possible, for example, by having the recoater blade rollers operate in such a way that the extruded log of material rolls without sliding at the recoater blade's speed of movement. The previously prepared foam may also be stored in a container and then pumped during the machine's operation.

In another embodiment, the raw material feed may be performed using a pressurized contained, which may be rechargeable, containing the photopolymerizable material, preferably a foaming agent and potentially appropriate loads and additives as well as a pressurized gas. The pressurized container is equipped with an adapted distribution valve allowing it to form and distribute the foam. Under these conditions, it is not necessary to use a pump, since the gas pressure allows for the foam distribution. It may be equipped with an expansion cavity or chamber in which the material expansion will take place. This cavity functions exactly like a normal feed piston's cylinder sleeve equipped for paste, except that to feed the recoater blade with material, the container must be released for a certain time, instead of mounting the piston at a certain distance. Material distribution control may be performed, for example, by computer system control of the distribution valve. This embodiment allows for the production of a specific quantity of foam corresponding to the amount necessary to create a specific number of layers. Sensors may be employed indicating the depletion of the material contained in the pressurized container, with said sensors being linked to the machine's control system to allow for an automatic shutdown of the machine in the event it runs out of raw material, and indicating to the user, by means of an audible alarm for example, the need to replace the empty container with a new one.

In another embodiment, the raw material feed takes place through a container equipped with a distribution valve which can be fed on one hand with a photopolymerizable paste or liquid from a piston, for example, and on the other hand, with a pressurized gas coming from a second container or an independent gas network. Said container may have an internal volume corresponding to the quantity of paste or liquid and gas necessary for the creation of one or more layers, with the container being automatically filled with gas and paste or liquid. Thus, a quantity of fresh foam may be formed during operation with the goal of creating one or more layers. In this latter case, the foam formed at the container's output may be stored in a piston used to feed the recoater blade with foam.

### DETAILED DESCRIPTION OF THE PREFERRED EMBODIMENTS

The invention shall be better comprised and other goals, details, features and benefits will appear more clearly in the following detailed description of two specific embodiments.

### EXAMPLE 1

In this example, the foam composition takes place by means of the following components:

acrylic resin marketed by the firm AKZO Chemicals under the trade name “Diacryl 101”

photoinitiator marketed by the company Ciba-Geigy under the trade name “Irgacure 651” (Dimethoxyphenyl-acetophenone)

foaming agent:

surface-active agent in the form of a powder: sodium dodecyl sulfate (C₁₂H₂₅NaSO₄)

water.

2.5% by weight of the photoinitiator is incorporated into the acrylic resin, preferably hot, for example, at a temperature between 40 and 50° C. Then 5% by weight of the surface-active agent is incorporated into the previously obtained resin-photoinitiator blend. Then, approximately 30% by weight of water is gradually incorporated into the resulting blend, while agitating it vigorously with a whisk or a food processor type blender.

A thick, highly aerated foam is obtained which has a low flow threshold permitting its use in prototyping procedures with traditional liquid stereolithography machines. The foam composition has a density of approximately 0.35, and a gas content on the order of 65% by volume (initial volume of the resin multiplied by 3). The foam composition is dissolved very quickly in acetone and isopropyl alcohol. The foam composition has a relatively low a reactivity to ultraviolet light and the three-dimensional parts obtained from this composition present very weak mechanical properties.

### EXAMPLE 2

Starting with the foam composition from example 1, approximately 70 g of the blend of the acrylic resin referenced above and the above-mentioned photoinitiator are gradually added with vigorous agitation in a blender for every 100 grams of foam composition from example 1. A foam composition less aerated than in example 1 is obtained, with a sufficient flow threshold (threshold material) to be used with a paste machine, such as the “Optoform” type machine mentioned above. The foam composition has a density of approximately 0.75, and a gas content on the order of 25% by volume. A volume of a few cubic centimeters of the foam composition is dissolved in several dozen seconds in isopropyl alcohol. The foam composition's reactivity to ultraviolet light and the mechanical properties of the three-dimensional parts obtained from this foam composition are better than in example 1. In addition, the composition's stability over time and its homogeneity are better than those of the composition from example 1.

Although the invention has been described in relation to two specific embodiments, it is clear that it is in no way limited thereto and that it includes all technical equivalents of the means described as well as the combination thereof if they fall within the framework of the invention.

What is claimed is:

1. A photopolymerizable foam composition for use in a prototyping procedure, characterized by the fact that it includes:
a liquid or pasty part including at least 35% by volume of photopolymerizable material, including at least one photosensitive resin and at least one photoinitiator and between 0 and 65% by volume of pulverulent and/or additive load(s) and
a gaseous part in the form of a gas dispersion in said liquid or pasty part, with the gas taking the form of bubbles in a proportion from 10 to 95% by volume with respect to the volume of the composition.

2. A composition in accordance with claim 1, characterized by the fact that it includes bubbles of a size smaller than 0.3 millimeter in a proportion of at least 30% by volume with respect to the total volume of bubbles.

3. A composition in accordance with claims 1 or 2, characterized by the fact that it includes from 30 to 95% bubbles by volume.

4. A composition in accordance with one of the foregoing claims, characterized by the fact that the composition is a threshold material.

5. A composition in accordance with one of the foregoing claims, characterized by the fact that the gas is air.

6. A composition in accordance with one of the foregoing claims, characterized by the fact that it includes a foaming agent type additive.

7. A composition in accordance with one of the foregoing claims, characterized by the fact that it includes a low pyrolysis residue pulverulent load such as a micronized wax.

8. A procedure for obtaining three-dimensional parts comprised of thin superimposed layers of raw material, obtained by the repetition of a cycle including one transformation stage of a layer which has just been placed by photopolymerization of the composition and a coating stage of the transformed layer by a new non-transformed layer, characterized by the fact that the layers are created using the composition in accordance with one of claims 1 through 7.

9. A procedure in accordance with claim 8, characterized by the fact that it includes, during at least one cycle, a stage of creation of the foam composition by dispersion of a gas in a photopolymerizable liquid or pasty part or by expansion of a blend including a gas and a photopolymerizable liquid or pasty part.

10. A procedure in accordance with claims 8 or 9, characterized by the fact that it includes an automatic final cleaning stage of the three-dimensional part by application of a solvent or immersion in a solvent.

11. A device for the embodiment of the procedure in accordance with one of claims 8 through 10, including:
means to induce the transformation of the raw material in a working field,
means for feeding the raw material,
means to perform at least one coating phase, with said means including at least one recoater blade and a drive mechanism for said recoater blade,
and means to move the volumes already transformed with respect to the working field, characterized by the fact that the feed means include a pressurized container containing the liquid or paste part of the foam composition and a means adapted to the container allowing for the expansion of the liquid or pasty part in order to form a specific quantity of foam composition for the creation of one or more layers.

12. A device in accordance with claim 11, characterized by the fact that the drive mechanism allows for the movement of transformed volumes in a solvent bath and which also includes means allowing for the extraction of the transformed volumes cleaned in said bath.

13. Three-dimensional parts obtained by the procedure in accordance with one of claims 8 through 10.

14. Use of a three-dimensional part in accordance with claim 13 for use as a model in “lost wax” type casting procedures.
